(19) United States
(12) Patent Application Publication
(10) Pub. No.: US 2022/0380129 A1
(43) Pub. Date: Dec. 1, 2022

(54) AUTOMATED STORAGE RETRIEVAL SYSTEM FOR LOADING GOODS AND METHOD FOR RECEIVING AND DELIVERING GOODS USING THE PICKUP DEVICE

(71) Applicant: Gachisoft Inc., Daejeon (KR)

(72) Inventor: Ho Yon KIM, Sejong (KR)

(73) Assignee: Gachisoft Inc., Daejeon (KR)

(21) Appl. No.: 17/488,866

(22) Filed: Sep. 29, 2021

(30) Foreign Application Priority Data
May 31, 2021 (KR) 10-2021-0070056

(51) Int. Cl. B65G 1/137

(52) U.S. Cl. CPC B65G 1/1375

(57) ABSTRACT

An automated storage retrieval system and method for receiving and delivering goods using a pickup device are provided. According to an embodiment, the automated storage retrieval system includes: a plurality of vertically loaded goods vertically stacked without a separate loading rack; a goods pickup device that includes a goods lift configured to lift at least one in a column of the vertically loaded goods in a vertical direction and a goods picker configured to approach a space generated by being lifted by the goods lift to take out goods placed in the space or load the goods into the space; and a goods buffer unit configured to carry the goods to take out or load the goods. In addition, an item picking method that directly takes out an item in goods instead of taking out the goods is also disclosed.

### CROSS-REFERENCE TO RELATED APPLICATION(S)

This application claims priority from Korean Patent Application No. 10-2021-0070056, filed on May 31, 2021, in the Korean Intellectual Property Office, the disclosure of which is incorporated herein by reference in its entirety.

### BACKGROUND

### 1. Field

The following description relates to an automated storage retrieval system.

### 2. Description of Related Art

Demand for automatic warehouse systems for automation of storage and handling of various items such as item boxes, tote boxes, and storage boxes is increasing. Since the general automatic warehouse system requires large fixed facilities such as pallets and racks, there is a disadvantage in that the automatic warehouse system may not dynamically adapt its storage capacity to an increasing or decreasing quantity. When the quantity is less than the expected quantity, the facilities are wasted, and when the quantity is more than the expected quantity, not only is it difficult to secure additional space, but it also costs a lot of money. Therefore, there is a need for a method in which a loading space can be flexibly changed and which requires less initial investment cost.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an automated storage retrieval system for loading goods and method for receiving and delivering goods using the pickup device capable of loading more goods in a small space and efficiently taking out the loaded goods. In addition, the present invention provides a method of taking out one of boxes such as storage containers or tote boxes that are densely stacked in a small space or picking items in the box.

In one general aspect, an automated storage retrieval system includes: a plurality of loaded goods vertically stacked without a separate loading rack; a goods pickup device that includes a goods lift configured to lift at least one in a column of the stacked loaded goods in a vertical direction and a goods picker configured to approach a space generated by being lifted by the goods lift to take out goods placed in the space or load the goods into the space.

The goods pickup device may lift second goods above first goods using a goods lift and take out the first goods under the second goods in a horizontal direction using the goods picker in a mode for taking out the first goods from a warehouse, and lift the second goods to be loaded above the first goods to be added by using the goods lift and approach a space generated by being lifted by the goods lift to insert the goods in the horizontal direction using the goods picker in a mode for taking out the first goods from a warehouse in a mode for adding the first goods to the warehouse.

The goods pickup device may include a body that is movable, vertical frames that are mounted vertically on both side surfaces of the body and vertically move up and down, a goods holder that is mounted on the vertical frame and lifts a side surface of the second goods in the vertical direction, and a goods picker that is mounted on the vertical frame to take out a side surface of the first goods in the horizontal direction or insert the first goods.

The goods pickup device may hang the upper second goods using the goods holder, then lift the second goods, and pull and take out the lower first goods using the goods picker.

The goods pickup device may include a body that is movable, vertical frames that are mounted vertically on both side surface of the body and vertically move up and down, a goods lift that is mounted on the vertical frame and lifts a lower surface of the second goods in a vertical direction, and a goods picker that is mounted on the vertical frame to horizontally take out or insert a lower surface of the first goods in a horizontal direction.

The goods lift may have two arms that enter an inside of the second goods, and the goods picker may have two arms that enter an inside of the first goods.

The goods lift may have a multi-stage structure comprising a first lift and a second lift expandable from the first lift and enter an inside of the second goods by extending the second lift from the first lift, and the goods picker may have a multi-stage structure including a first picker and a second picker expandable from the first picker and enter an inside of the first goods by extending the second picker from the first picker.

Each of the goods may include an insertion hole into which at least one of the goods lift and the goods picker is inserted.

The automated storage retrieval system may further include a management server configured to store location information in a warehouse of goods and an item in the goods which matches identification information on recognized goods and the item in the goods, a recognition unit configured to recognize identification information on goods picked by the goods pickup device and an item in the goods, and a control unit configured to request the location information in the warehouse of the goods and the items in the goods that match the identification information on the recognized goods and the item in the goods from the management server to acquire the location information.

The automated storage retrieval system may further include an item picker that is mounted on the goods pickup device to take out a predetermined item in the goods taken out through the goods pickup device and load the taken-out item into a separate container.

The automated storage retrieval system may further include a goods buffer unit that supplies goods to the goods pickup device one by one or loads the goods picked by the picking device, or a goods buffer unit (goods loading buffer) that discharges and stores the item in the goods picked by the goods pickup device. The goods buffer unit may be integrated into the automated storage retrieval system or may be configured as a separate loading robot that may move independently. The goods loading unit may be configured to place goods one by one, or configured to stack a plurality of goods to increase loading efficiency. A goods holder may be used to place stacked goods on a column of other stacked goods for transport.

In another general aspect, a method of receiving goods using a pickup device includes acquiring, by a recognition unit, identification information on an item to be newly received and first goods loaded with the item, picking, by a goods pickup device, the first goods recognized using the acquired identification information, determining, by a control unit, a location where the first goods is to be loaded in a warehouse, lifting, by the goods pickup device, second goods above the first goods using a goods lift, approaching, by the goods pickup device, a space generated by being lifted by the goods lift and loading the first goods into the space by using a goods picker, and storing, by the storage unit, the loaded location information.

In another general aspect, a method of delivering goods using a pickup device includes acquiring, by a recognition unit, identification information on an item to be newly delivered and first goods loaded with the item, retrieving, by a control unit, a location of goods loaded with first goods to be delivered by using the acquired identification information, lifting, by the goods pickup device, second goods above the first goods using a goods lift, approaching, by the goods pickup device, a space generated by being lifted by the goods lift to pick the first goods loaded into the space by using a goods picker, and moving, by the goods pickup device, the picked goods to the goods buffer unit.

In another general aspect, a method of delivering an item using a pickup device includes acquiring, by a recognition unit, identification information on an item to be newly delivered and first goods loaded with the item, retrieving, by a control unit, a location of goods loaded with first goods to be delivered by using the acquired identification information, lifting, by the goods pickup device, second goods above the first goods using a goods lift, approaching, by the goods pickup device, a space generated by being lifted by the goods lift to pick the first goods loaded into the space by using a goods picker, recognizing the item in the first goods through the recognition unit, and taking out, by the goods pickup device, the recognized item through the item picker and loading the taken-out item into the corresponding goods among the goods in the goods buffer unit.

Other features and aspects will be apparent from the following detailed description, the drawings, and the claims.

### BRIEF DESCRIPTION OF THE DRAWINGS

FIG. 1 is a diagram illustrating an appearance of an automated storage retrieval system according to an embodiment of the present invention.

FIG. 2 is a diagram illustrating an operation of a goods pickup device taking out predetermined goods from a warehouse according to an embodiment of the present invention.

FIG. 3 is a diagram illustrating the appearance of the goods pickup device of FIG. 2 according to an embodiment of the present invention.

FIG. 4 is a diagram illustrating an example of moving the goods pickup device to the warehouse according to an embodiment of the present invention.

FIG. 5 is a diagram illustrating an operation of taking out goods using the goods pickup device according to an embodiment of the present invention.

FIG. 6 is a diagram illustrating a goods holder of the goods pickup device of FIG. 5 according to the embodiment of the present invention.

FIG. 7 is a diagram illustrating an appearance of an automated storage retrieval system according to another embodiment of the present invention.

FIG. 8 is a diagram illustrating an operation process of the automated storage retrieval system of FIG. 7 according to the embodiment of the present invention.

FIG. 9 illustrates a diagram (FIG. 9A) illustrating an example of taking out goods using a goods picker of the goods pickup device and a diagram (FIG. 9B) illustrating an example of inserting goods using the goods picker of the goods pickup device according to an embodiment of the present invention.

FIG. 10 is a diagram illustrating a structure of a goods lift according to an embodiment of the present invention.

FIG. 11 is a diagram illustrating goods loaded in the warehouse according to the embodiment of the present invention.

FIG. 12 is a diagram illustrating two-stage goods of FIG. 11.

FIG. 13 is a diagram illustrating a flow of a method of receiving goods using a pickup device according to an embodiment of the present invention.

FIG. 14 is a diagram illustrating a flow of a method of delivering goods using a pickup device according to an embodiment of the present invention.

FIG. 15 is a diagram illustrating a goods buffer unit or a discharge unit according to an embodiment of the present invention.

FIG. 16 is a diagram illustrating a state in which a goods loading unit or a goods buffer unit is separated and configured in a separate transport robot according to an embodiment of the present invention.

FIG. 17 is a diagram illustrating a method of transporting vertically stacked goods columns and adding the columns to the existing stacked goods column one by one or lifting all the columns according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Various advantages and features of the present invention and methods accomplishing the same will become apparent from the following detailed description of embodiments with reference to the accompanying drawings. However, the present invention is not limited to exemplary embodiments to be described below but may be implemented in various different forms, these exemplary embodiments will be provided only in order to make the present invention complete and allow those skilled in the art to completely recognize the scope of the present invention, and the present invention will be defined by the scope of the claims. Throughout the specification, like reference numerals denote like elements.

When it is determined that the detailed description of the known functions or configurations in describing the embodiments of the present invention may obscure the gist of the present invention, the detailed description thereof will be omitted, and the following terminologies are defined in consideration of the functions in the embodiments of the present invention and may be construed in different ways by users, an intention of operators, or conventions. Therefore, the definitions thereof should be construed based on the contents throughout the specification.

In addition, each block or each step may indicate some of modules, segments, or codes including one or more executable instructions for executing a specific logical function (specific logical functions). Further, it is to be noted that functions described in the blocks or the steps occur regardless of a sequence in some alternative embodiments. For example, two blocks or steps that are consecutively shown may actually be simultaneously performed or performed in a reverse sequence depending on corresponding functions.

Hereinafter, embodiments of the present invention will be described in detail with reference to the accompanying drawings. Exemplary embodiments in the present invention may be modified in many different forms and the scope of the present invention is limited to exemplary embodiments to be described below. The embodiments of the present invention are provided to more completely explain the present invention to those of ordinary skill in the art to which the present invention pertains.

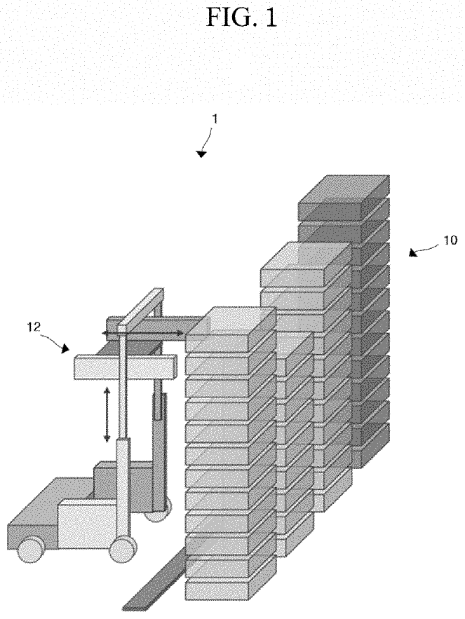

FIG. 1 is a diagram illustrating an appearance of an automated storage retrieval system according to an embodiment of the present invention.

Referring to FIG. 1, the automated storage retrieval system 1 includes a warehouse 10 and a goods pickup device 12.

A plurality of goods are vertically stacked in the warehouse 10. In this case, note that only the goods themselves are stacked in the warehouse 10 without a separate loading rack. The goods may be in the form of general goods, tote boxes, and the like. In this case, a plurality of items may be loaded into each of the goods.

The goods pickup device 12 picks and takes out predetermined goods in the warehouse 10 and brings the taken-out goods to an exit, or picks the goods at an entrance and loads the picked goods into the warehouse 10.

In general, automated warehouses require huge rack facilities. For example, when there is a need to find and bring necessary goods while storing goods, but shuttle racks or carts move along rails to bring goods, as a result, large-scale rack equipment is required. However, the goods pickup device 12 according to the embodiment allows goods to be stored in the warehouse 10 more flexibly and to bring necessary goods without the above-described large-scale rack facility. In this case, the goods pickup device 12 should be able to freely take out any goods from among goods stacked one after another or to load goods at any location.

Referring to FIG. 1, when a plurality of goods are stacked, in the case of the conventional method, in order to take out predetermined goods in the middle, all goods above the goods to be taken out need to be put down. However, in the automated storage retrieval system 1 according to the embodiment, the goods pickup device 12 may take out desired goods in a manner of lifting goods above the goods to be taken out and horizontally taking out only goods under the goods to be taken out. Therefore, even when the warehouse 10 stacks goods, the desired goods can be taken out through the goods pickup device 12.

In order to vertically stack items on a shelf, a drawer, or the like, and take out the items, a separate space is required. For example, in the case of the shelf, it is necessary to secure a height of the shelf to take out an inner shelf. In the case of the drawer, since a space is required in front of the drawer, more than twice the space into which goods are loaded is also required.

However, since the automated storage retrieval system according to the embodiment can load and take out goods without the above-described separate space, the space may be efficiently used. In this case, the automated storage retrieval system may load many kinds of goods in a small space or take out the loaded goods. For example, the automated storage retrieval system stacks goods vertically but stacks goods without space to take out the goods. The automated storage retrieval system generates a space by lifting at least one goods stacked vertically above predetermined goods to take out the goods and then takes out the goods in the generated space.

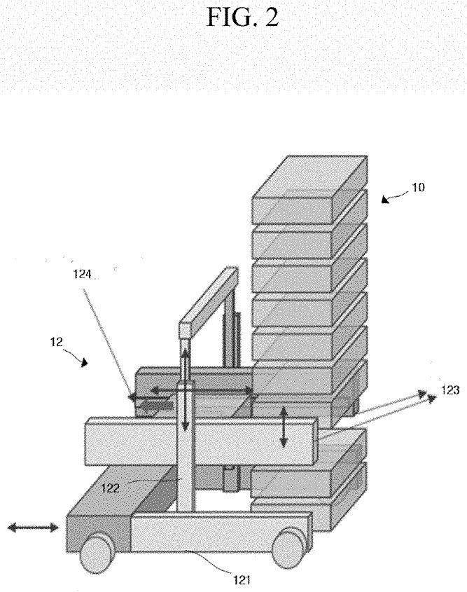

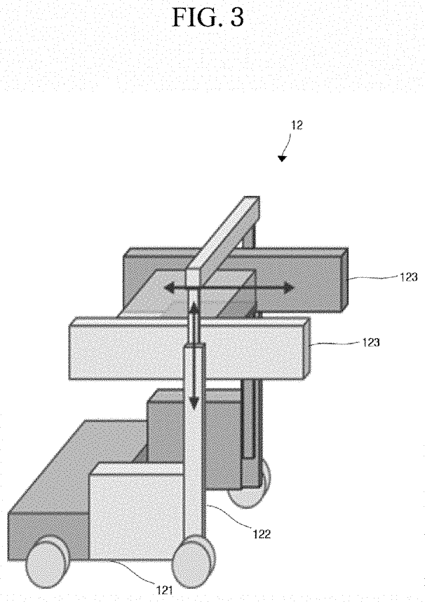

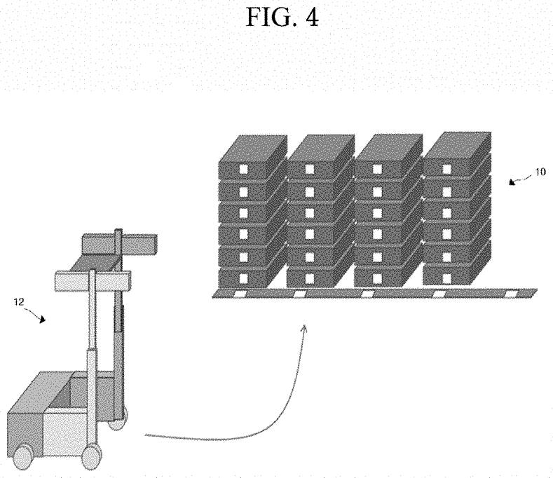

FIG. 2 is a diagram illustrating an operation of a goods pickup device taking out a predetermined goods from a warehouse according to an embodiment of the present invention, FIG. 3 is a diagram illustrating the appearance of the goods pickup device of FIG. 2, and FIG. 4 is a diagram illustrating an example of moving the goods pickup device to the warehouse.

Referring to FIGS. 2 to 4, the goods pickup device 12 slightly lifts second goods above first goods to take out the first goods in the middle from warehouse 10, takes out the first goods, and then puts the second goods down again.

Hereinafter, a structure of the goods pickup device 12 will be described. The goods pickup device 12 according to an embodiment includes a body 121, a vertical frame 122, a goods holder 123, and a goods picker 124.

The body 121 is equipped with wheels and is thus movable. The vertical frame 122 is vertically mounted on both side surfaces of the body 121 and vertically moves up and down. To this end, the vertical frame 122 is configured in multiple stages and may move up and down.

The goods holder 123 is mounted on the vertical frame 122 and lifts a side surface of the second goods in a vertical direction. The goods holder 123 may have an arm structure in which arms may be elongated or extended in both front directions to prevent a center of the goods from collapsing when lifting the goods.

The goods may have a structure that is easy for the goods holder 123 to hold. For example, a groove may be formed in the side surface so that the goods holder 123 may be inserted, a protruding part like a handle may be formed between upper and lower goods stacked, and a hole may be formed.

The goods picker 124 is mounted on the vertical frame 122 to take out or insert a side surface of the first goods in the horizontal direction. The goods picker 124 may include a goods picking rail that guides the horizontal movement of goods as illustrated in FIG. 2. In this case, the goods picker 124 takes out or inserts the goods in the horizontal direction along the goods picking rail. As another example, the goods picker 124 may have a long arm structure or an extendable arm structure.

The goods pickup device 12 may further include a recognition unit and a control unit. The recognition unit recognizes identification information on goods and items in the goods. Since goods and a plurality of items in the goods each have identification information such as barcode or radio frequency identification (RFID), the recognition unit recognizes the identification information. The recognition unit may be a scanner, a vision camera, a barcode reader, an RFID reader, or the like. The recognition unit may be located on a ceiling or a side surface of the goods pickup device 12.

When the control unit needs to bring a first item from the warehouse, the control unit retrieves the first goods including the first item from a management server and brings location information (coordinates and loaded height) with the retrieved first goods from the management server. The location information matching the identification information on goods and items in the goods is stored in the management server. That is, the management server includes information on which goods are located in which location in the warehouse and which items are loaded in the goods.

Hereinafter, the operation of taking out the first goods in the warehouse 10 using the goods pickup device 12 having the above-described structure will be described below.

First, when the control unit of the goods pickup device 12 needs to bring the first item from the warehouse, the control unit retrieves the first goods including the first item from a management server and brings the location information (coordinates and loaded height) with the retrieved first goods from the management server. Then, the goods pickup device 12 moves to the location of the first goods using the location information.

Next, the goods pickup device 12 recognizes the goods through the recognition unit and checks whether the recognized goods are the first goods. When the recognized goods are the first goods, the goods pickup device 12 lifts the second goods above the first goods through the goods holder 123. In this case, all the goods above the second goods are lifted at once.

Then, the goods pickup device 12 takes out the first goods in the horizontal direction through the goods picker 124 and places the second goods, which are above the first goods, down vertically through the goods holder 123 and loads the second goods again.

Next, the goods pickup device 12 may discharge the first goods taken out of the warehouse to the discharge chute. Furthermore, the goods pickup device 12 may pick a predetermined item in the first goods using the item picking device and then discharge the picked item to the discharge chute. In this case, when there are items left in the first goods, the first goods are returned to an original location again, and there is no need to put the second goods down vertically.

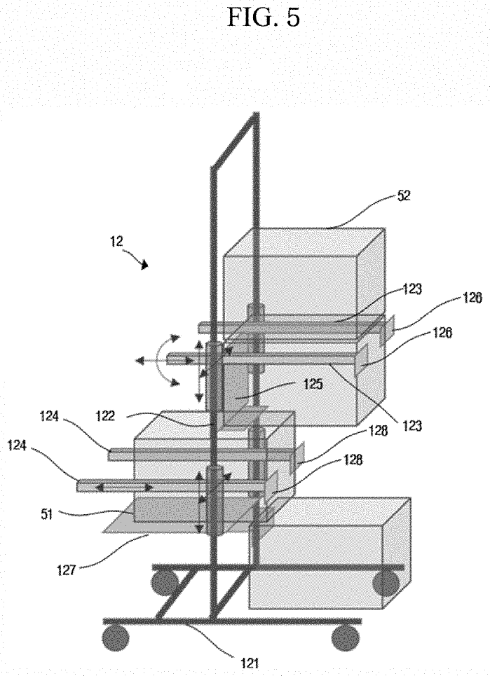

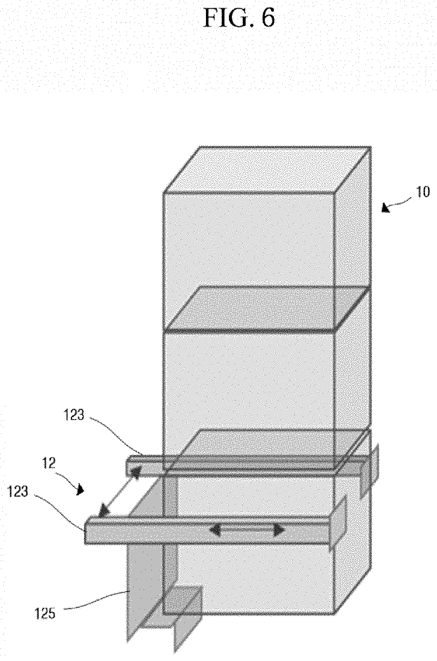

FIG. 5 is a diagram illustrating an operation of taking out goods using a goods pickup device according to an embodiment of the present invention, and FIG. 6 is a diagram illustrating a goods holder of the goods pickup device of FIG. 5.

Referring to FIGS. 5 and 6, the goods pickup device 12 according to the embodiment includes a body 121, a vertical frame 122, a goods holder 123, and a goods picker 124.

The body 121 is equipped with wheels and is thus movable. The vertical frame 122 is vertically mounted on both side surfaces of the body 121 and vertically moves up and down. To this end, the vertical frame 122 is configured in multiple stages and may move up and down.

The goods holder 123 is mounted on the vertical frame 122 and lifts a side surface of the second goods 52 in a vertical direction. The goods holder 123 may include two long arms as illustrated in FIG. 5 and may have an extendable structure. The goods holder 123 may have an arm structure in which arms may be elongated or extended in both front directions to prevent a center of the second goods 52 from collapsing when lifting the second goods 52. The goods holder 123 may include a second pedestal 125 temporarily supporting the side surface of the second goods 52 and a first fixing member 126 that holds the second goods 52 so that the second goods 52 are not put down when lifting the goods holder 123. The second pedestal 125 may be a shelf.

The goods picker 124 is mounted on the vertical frame 122 to take out or insert the side surface of the first goods in the horizontal direction. The goods picker 124 may be constituted by two long arms as shown in FIG. 5, and the two arms may have a structure that may be extended. The goods picker 124 may include a first pedestal 127 that temporarily supports a lower surface of the first goods 51, and a second fixing member 128 that holds the second goods 52 to pull the first goods 51. The first pedestal 127 may be a shelf.

Instead of lifting the second goods 52 vertically, the goods holder 123 may push up the second goods 52. Here, the pushing up opens a gap and means that the goods holder 123 places the first pedestal 127 on the first goods 51 directly under the second goods 52, and the goods holder 123 pushes the first goods 51 as if opening a gap. Just as when a person lifts goods, he/she holds goods with both arms and supports and lifts the goods with his/her stomach, the two arms of the goods holder 123 are configured so that the arms that spread from both sides may slightly pull goods so that the upper goods may be put on. The goods pickup device 12 places the upper second goods 52 using the goods holder 123, then slightly lifts the second goods 52, and uses the goods picker 124 to pull out and take out the lower first goods 51. In this way, the first goods 51 may be taken out even when there is no gap between the handles on both sides of the first goods 51 in the middle.

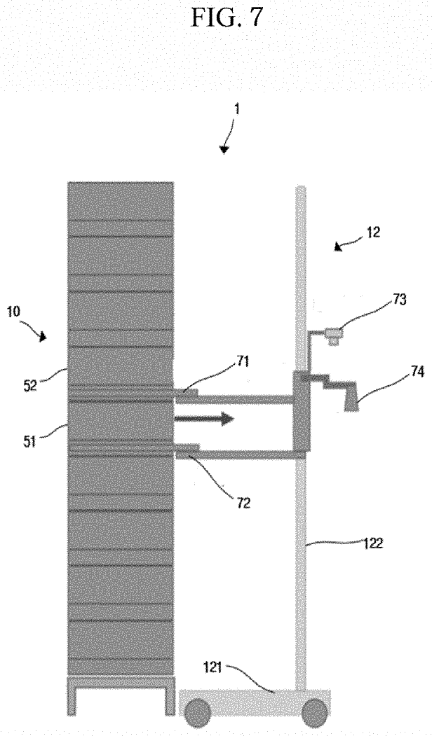

FIG. 7 is a diagram illustrating an appearance of an automated storage retrieval system according to another embodiment of the present invention.

Referring to FIG. 7, the automated storage retrieval system 1 includes vertically loaded goods 10 and a goods pickup device 12, and the goods pickup device 12 includes a body 121, a vertical frame 122, a goods lift 71, and a goods picker 72.

The body 121 is equipped with wheels and is thus movable. The vertical frame 122 is vertically mounted on both side surfaces of the body 121 and vertically moves up and down.

The goods lift 71 is mounted on the vertical frame 122 and lifts the lower surface of the second goods above the first goods to be taken out or inserted in the vertical direction. Although the goods holder 123 described above with reference to FIGS. 5 and 6 has a structure to hold and lift the side surface of the second goods, the goods lift 71 lifts a lower end of the second goods without needing to hold the side surface of the second goods. In the case of the goods holder 123, left and right locations of the goods holder 123 need to be aligned for holding goods, widths thereof need to be adjusted to correspond to sizes of the second goods, and stop locations thereof also need to be precisely controlled. However, since the goods lift 71 only needs to lift the second goods, the precise control is unnecessary, and thus, the operation is simple.

The goods picker 72 is mounted on the vertical frame 122 to take out or insert the lower surface of the first goods to be taken out or inserted in the horizontal direction.

In the structure of FIG. 7, the goods lift 71 and the goods picker 72 are tied in the same structure to lift the goods upward, and thus a separate power may not be used. However, when lifting the goods, the lower first goods 51 may be made to sag slightly downward, and thus, it is easy to take out the lower first goods 51.

When adding the first goods 51 to the warehouse 10, the first goods 51 may be inserted under the second goods 52 or inserted above the second goods 52, but the taken-out location may be any location. The goods picker 72 may recognize the identification information on the item in the first goods 51 through a recognition unit 73 after taking out the first goods 51 from the warehouse, take out the recognized item using an item picker 74, and place the taken-out item in a separate container. The recognition unit 73 may be a scanner, a camera, or the like.

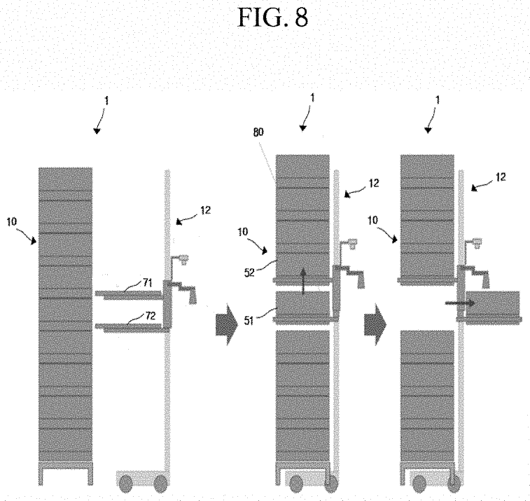

FIG. 8 is a diagram illustrating an operation process of the automated storage retrieval system of FIG. 7 according to the embodiment of the present invention.

Referring to FIGS. 7 and 8, in the automated storage retrieval system, the goods pickup device 12 retrieves the location of the first goods 51 loaded with the item to be picked up and approaches the location of the retrieved first goods 51 (see FIG. 8A). In this case, the goods lift 71 of the goods pickup device 12 is adjusted up and down to a location where the second goods 52 on the second goods 52 may be lifted, and the goods picker 72 may be adjusted up and down to a location where the first goods 51 may be taken out.

Then, in the goods pickup device 12, the two arms of the goods lift 71 enter the inside of the second goods 52 and lift the second goods 52 (see FIG. 8B). When the second goods 52 are lifted, all goods above the second goods 52 are lifted at once.

Then, in the goods pickup device 12, the two arms of the goods lift 71 enter the inside of the first goods 51 and lift the first goods 51, and then take out the first goods 51 (see FIG. 8C).

As illustrated in FIG. 8, the two arms of the goods lift 71 may enter the inside of the second goods 52, and the two arms of the goods picker 72 may enter the inside of the first goods 51, but the lift of the goods lift 71 may be increased, and thus, the goods lift 71 may enter the inside of the second goods 52, and the picker of the goods picker 72 may be increased, and thus, the goods picker 72 may enter the inside of the first goods 51. For example, the goods lift 71 includes the first lift and the second lift expandable from the first lift and extends the second lift from the first lift to enter the inside of the second goods 52. The goods picker 72 has a multi-stage structure including a first picker and a second picker expandable from the first picker, and enters an inside of the first goods by extending the second picker from the first picker.

As shown in reference numeral 80 in FIG. 8, it may be confirmed that the gap is automatically widened by the weight of the goods.

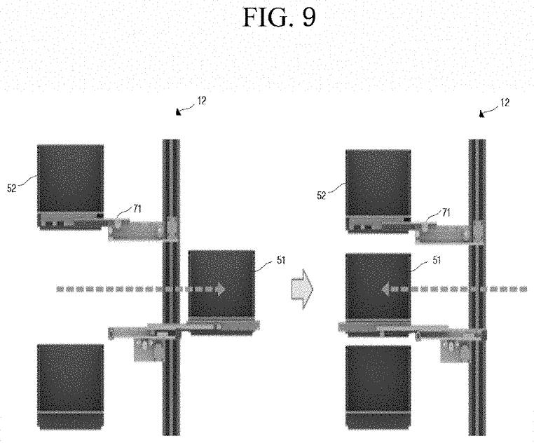

FIG. 9 shows a diagram (FIG. 9A) illustrating an example of taking out goods using the goods picker of the goods pickup device and a diagram (FIG. 9B) illustrating an example of inserting goods using the goods picker of the goods pickup device according to an embodiment of the present invention.

Referring to FIG. 9, the goods pickup device 12 may take out the first goods 51 from the warehouse 10 by moving the two arms of the goods picker 72 to the opposite side of the warehouse 10 in the horizontal direction (see FIG. 9A), and the goods pickup device 12 may also insert the first goods 51 into warehouse 10 by moving two arms of the goods picker 72 in the direction of warehouse 10 in the horizontal direction (see FIG. 9B).

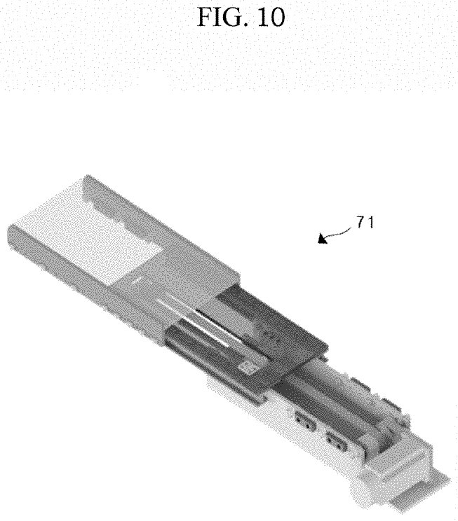

FIG. 10 is a diagram illustrating a structure of a goods lift according to an embodiment of the present invention.

Referring to FIG. 10, the goods lift 71 has a multi-stage structure in which a plurality of lifts are connected to be able to extend a predetermined lift among the lifts. In this case, the extended lift is increased and thus enters the inside of the second goods to be lifted. Since the goods lift only needs to lift a bottom surface of the second goods to be lifted, it is unnecessary to align the left and right locations required for holding, and there is no need to be precise.

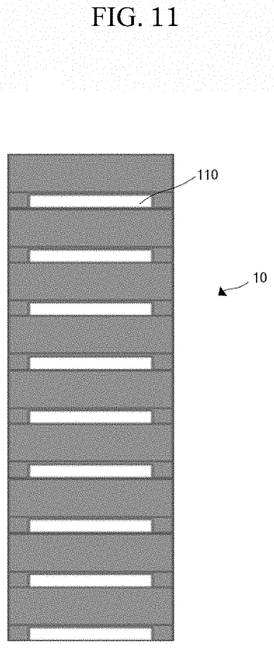

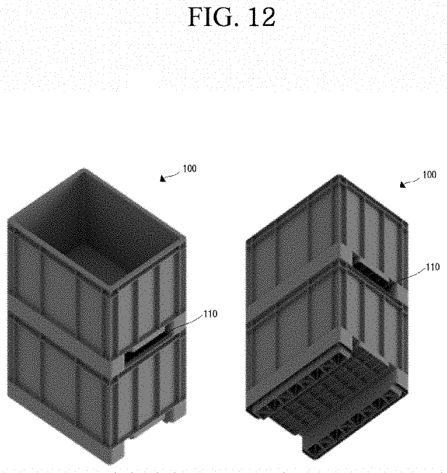

FIG. 11 is a diagram illustrating goods loaded in a warehouse according to an embodiment of the present invention, and FIG. 12 is a diagram illustrating a second-stage goods of FIG. 11.

Referring to FIGS. 11 and 12, an insertion hole 110 is made under goods like a flat pallet mainly used in an existing logistics system, and thus, the goods lift may enter the insertion hole 110. FIG. 12 shows diagrams viewed from the front (FIG. 12A) and the bottom (FIG. 12B) of goods 100 vertically loaded in two stages.

In this way, goods may be stacked vertically even without a loading rack, and goods may be taken out at any location in the middle, or items in the goods may be taken out. Of course, it may also be configured to process several orders at the same time.

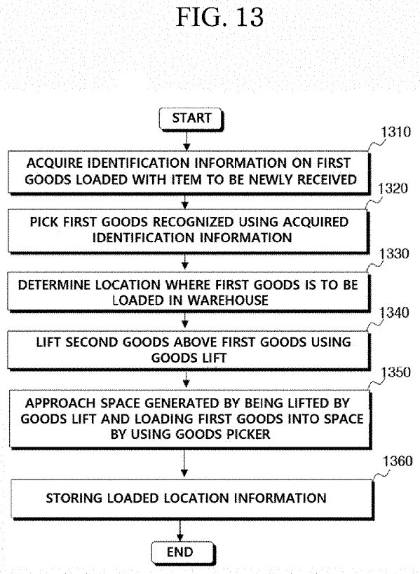

FIG. 13 is a diagram illustrating a flow of a method of receiving goods using a pickup device according to an embodiment of the present invention.

Referring to FIG. 13, the recognition unit receives identification information on an item to be newly received and first goods loaded with the item (1310). In this case, the identification information may be received and measured. The identification information is information that may identify goods or items, and includes, for example, barcode, RFID, or the like. The management server has location information on which goods are in which location in the warehouse.

Next, the goods pickup device picks the first goods recognized using the acquired identification information (1320).

Next, the control unit determines a location where the first goods are to be loaded in a warehouse (1330).

Next, the goods pickup device lifts the second goods above the first goods by using the goods lift (1340), and the goods picker approaches the space generated by being lifted by the goods lift and loads the first goods into the space (1350).

Next, the storage unit stores the loaded location information (1360).

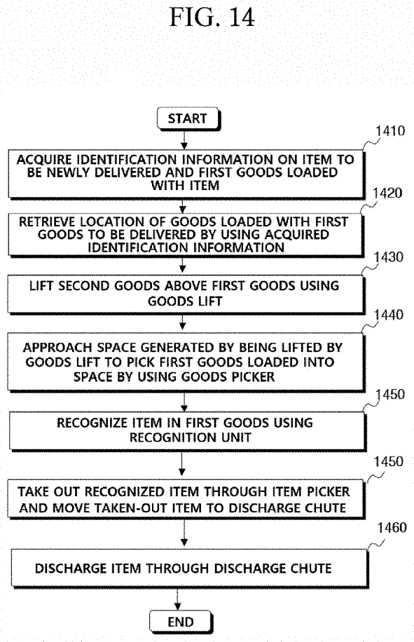

FIG. 14 is a diagram illustrating a flow of a method of delivering goods using a pickup device according to an embodiment of the present invention.

Referring to FIG. 14, the recognition unit receives the identification information on an item to be delivered and the first goods loaded with the item (1410). In this case, the identification information may be received and measured. The identification information is information that may identify goods or items and includes, for example, barcode, RFID, or the like. The management server has location information on which goods are in which location in the warehouse.

Next, the control unit retrieves the location of the first goods to be delivered using the acquired identification information (1420). When the identification information is known, by requesting the management server, it is possible to retrieve the location information on where the first goods are loaded in the warehouse.

Next, the goods lift of the goods pickup device lifts the second goods above the retrieved first goods (1430). And, the goods picker of the goods pickup device approaches the space generated by being lifted by the goods lift to pick the first goods loaded in the space and takes out the picked first goods in the horizontal direction (1440).

Next, the recognition unit of the goods pickup device recognizes the item in the first goods taken out (1450).

Next, the item picker of the goods pickup device takes out the recognized item in the first goods, moves the taken-out item to the goods buffer unit or the discharge chute (1450), and discharges the goods in the goods loading unit or the discharge chute from the destination (1460).

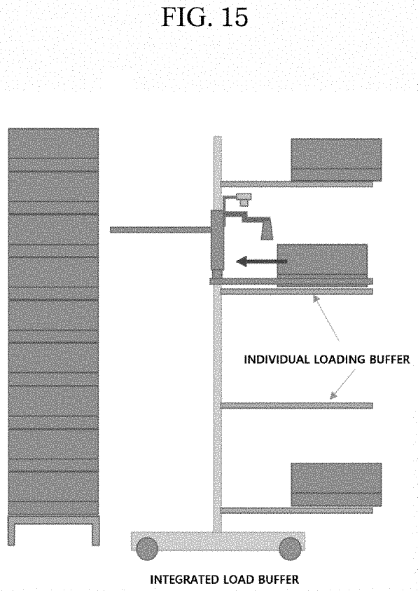

FIG. 15 is a diagram illustrating the goods buffer unit or the discharge unit according to an embodiment of the present invention.

When taking out goods or items, there may be further provided a storage stand on which the goods or items may be placed and, as can be seen with reference to FIG. 15, the storage stand may be integrally configured.

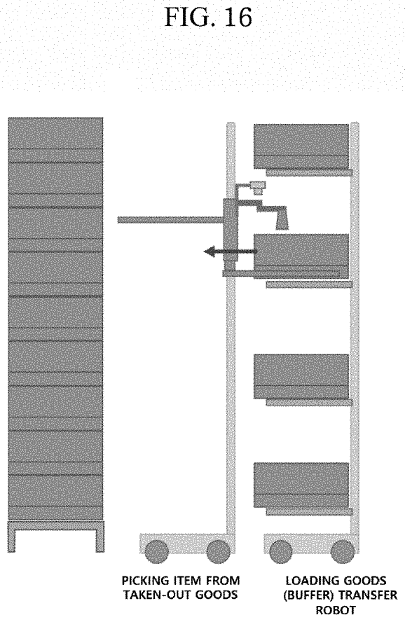

FIG. 16 is a diagram illustrating a state in which a goods loading unit or a goods buffer unit is separated and configured in a separate transport robot according to an embodiment of the present invention.

As described with reference to FIG. 16, it can be seen that the goods loading unit or the goods buffer unit may be separated and configured in the separate transport robot.

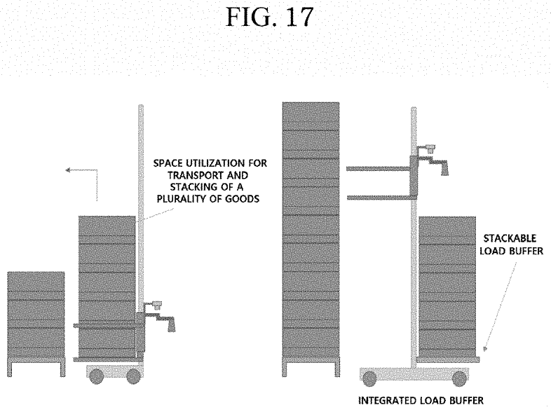

FIG. 17 is a diagram illustrating a method of transporting vertically stacked goods columns and adding the columns to the existing stacked goods column one by one or lifting up all the columns according to an embodiment of the present invention.

As described with reference to FIG. 17, a separate box transport robot that transports several boxes may be used. The separate box transport robot is possible to carry several boxes to process several orders or add or remove multiple boxes. This is to carry and process several boxes at once. Of course, the goods picker needs to be configured to reach the separate box transport robot, and individual items may also be placed here.

According to an embodiment, an automated storage retrieval system and a method for receiving and delivering goods using the pickup device can load more goods in a small storage space and efficiently take out the loaded goods. For example, a plurality of goods are vertically stacked in multiple layers, and a separate space is not required to take out goods required in a drawer type or the like, and thus a warehouse can be used more widely and space efficiency can be increased. In addition, goods can be freely stacked without a separate loading rack, and as a result, a layout can be easily changed and a warehouse can be moved to a larger place or expanded.

Furthermore, various applications are possible because it is possible to not only pick goods using a goods pickup device, but also pick items inside the goods.

Hereinabove, the present invention has been described with reference to exemplary embodiments thereof. It will be understood by those skilled in the art to which the present invention pertains that the present invention may be implemented in a modified form without departing from essential characteristics of the present invention. Therefore, the exemplary embodiments disclosed herein should be considered as an illustrative aspect rather than a restrictive aspect. The scope of the present invention should be defined by the claims rather than the above-described description, and equivalents to the claims should be interpreted to fall within the present invention.

What is claimed is:

1. An automated storage retrieval system comprising:
vertically loaded goods vertically stacked without a separate loading rack; and
a goods pickup device that includes a goods lift configured to lift at least one in a column of the vertically loaded goods in a vertical direction and a goods picker configured to approach a space generated by being lifted by the goods lift to take out goods placed in the space or load new goods into the space.

2. The automated storage retrieval system of claim 1, wherein the goods pickup device lifts second goods above first goods using a goods lift and takes out the first goods under the second goods in a horizontal direction using the goods picker in a mode for taking out the first goods from a warehouse, and
lifts the second goods to be loaded above the first goods to be added by using the goods lift and approaches a space generated by being lifted by the goods lift to insert the goods in the horizontal direction using the goods picker in a mode for taking out the first goods from a warehouse in a mode for adding the first goods to the warehouse.

3. The automated storage retrieval system of claim 1, wherein the goods pickup device includes:
a body that is movable;
vertical frames that are mounted vertically on both side surfaces of the body;
a transport system that is mounted on the vertical frame and moves up and down to lift or move goods;
a goods holder that is mounted on the transport system to vertically lift a side surface of the second goods; and
a goods picker that is mounted in the transport system to horizontally take out or insert a side surface of the first goods.

4. The automated storage retrieval system of claim 3, wherein the goods pickup device hangs the upper second goods using the goods holder, then lifts the second goods, and pulls and takes out the lower first goods using the goods picker.

5. The automated storage retrieval system of claim 1, wherein the goods pickup device includes:
a body that is movable;
vertical frames that are mounted vertically on both side surfaces of the body;
a transport system that is mounted on the vertical frame and moves up and down to lift or move goods;
a goods lift that is mounted on the transport system and lifts a lower surface of the second goods in a vertical direction; and
a goods picker that is mounted in the transport system to horizontally take out or insert a lower surface of the first goods in a horizontal direction.

6. The automated storage retrieval system of claim 5, wherein the goods lift has two arms that enter an inside of the second goods, and the goods picker has two arms that enter an inside of the first goods.

7. The automated storage retrieval system of claim 5, wherein the goods lift has a multi-stage structure comprising a first lift and a second lift expandable from the first lift and enters an inside of the second goods by extending the second lift from the first lift, and
the goods picker has a multi-stage structure including a first picker and a second picker expandable from the first picker and enters an inside of the first goods by extending the second picker from the first picker.

8. The automated storage retrieval system of claim 1, wherein each of the goods includes an insertion hole into which at least one of the goods lift and the goods picker is inserted.

9. The automated storage retrieval system of claim 1, further comprising:
a management server configured to store location information in a warehouse of goods and an item in the goods which matches identification information on recognized goods and the item in the goods;
a recognition unit configured to recognize identification information on goods picked by the goods pickup device and an item in the goods; and
a control unit configured to request the location information in the warehouse of the goods and the items in the goods that match the identification information on the recognized goods and the item in the goods from the management server to acquire the location information.

10. The automated storage retrieval system of claim 1, further comprising an item picker that is mounted on the transport system to take out a predetermined item in the goods taken out through the goods pickup device and load the taken-out item into a separate container.

11. The automated storage retrieval system of claim 1, further comprising a vision camera that is mounted on the transport system and photographs and recognizes a predetermined item in the goods to take out the predetermined item in the goods taken out through the goods pickup device.

12. The automated storage retrieval system of claim 1, further comprising at least one of:
a goods supply unit configured to supply goods to the goods pickup device one by one; and
a discharge chute configured to discharge at least one goods or an item in the goods picked by the goods pickup device.

13. A method of receiving goods using a pickup device, comprising:
acquiring, by a recognition unit, identification information on an item to be newly received and first goods loaded with the item;
picking, by a goods pickup device, the first goods recognized using the acquired identification information;
determining, by a control unit, a location where the first goods is to be loaded in a warehouse;
lifting, by the goods pickup device, second goods above the first goods using a goods lift;
approaching, by the goods pickup device, a space generated by being lifted by the goods lift and loading the first goods into the space by using a goods picker; and
storing, by the storage unit, the loaded location information.

14. A method of delivering goods using a pickup device, comprising:
acquiring, by a recognition unit, identification information on an item to be newly delivered and first goods loaded with the item;
retrieving, by a control unit, a location of goods loaded with first goods to be delivered by using the acquired identification information;
lifting, by the goods pickup device, second goods above the first goods using a goods lift;
approaching, by the goods pickup device, a space generated by being lifted by the goods lift to pick the first goods loaded into the space by using a goods picker;
recognizing, by the goods pickup device, an item in the first goods by using a recognition unit;
taking out, by the goods pickup device, the recognized item through an item picker and moving the taken-out item to a discharge chute; and
discharging, by the discharge chute, the item.
